(19) United States
(12) Patent Application Publication
(10) Pub. No.: US 2024/0333021 A1
(43) Pub. Date: Oct. 3, 2024

(54) SOLAR CHARGING SYSTEM

(71) Applicant: TOYOTA JIDOSHA KABUSHIKI KAISHA, Toyota-shi (JP)

(72) Inventors: Yukinori MURAKAMI, Toyota-shi (JP); Yuma MIYAMOTO, Miyoshi-shi (JP)

(73) Assignee: TOYOTA JIDOSHA KABUSHIKI KAISHA, Toyota-shi (JP)

(21) Appl. No.: 18/600,328

(22) Filed: Mar. 8, 2024

(30) Foreign Application Priority Data
Mar. 27, 2023 (JP) 2023-050118

(51) Int. Cl. H02J 7/35; B60L 53/51; H02J 7/34

(52) U.S. Cl. CPC H02J 7/35; B60L 53/51; H02J 7/342; H02J 2207/50

(57) ABSTRACT

A solar charging system includes a solar panel, a first battery configured to be charged with electric power generated by the solar panel, a converter configured to convert electric power stored in the first battery and electric power generated by the solar panel, a second battery configured to be charged with the electric power converted by the converter, and processing circuitry. The converter includes a capacitor configured to reduce a potential difference between the second battery and the converter using a stored charge. The processing circuitry is configured to charge the capacitor by supplying electric power generated by the solar panel and electric power stored in the first battery to the capacitor, and start charging the second battery after charging the capacitor until an amount of charge of the capacitor is greater than or equal to a first prescribed value.

### BACKGROUND

### 1. Field

The present disclosure relates to a solar charging system.

### 2. Description of Related Art

A solar charging system described in Japanese Patent No. 7180295 includes a solar panel, a first battery, a second battery, and a solar ECU including a converter. The first battery is charged with electric power generated by the solar panel. The converter converts electric power generated by the solar panel and electric power stored in the first battery. The second battery stores electric power by being supplied with the electric power converted by the converter.

When electric power is supplied from the converter to the second battery to start charging the second battery, an inrush current may flow from the second battery to the converter due to a potential difference between the converter and the second battery. Therefore, a precharge circuit for suppressing an inrush current to the converter may be connected between the converter and the second battery.

There is a need for a configuration that prevents inrush current from flowing to a converter without providing a precharge circuit in a solar charging system.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a solar charging system includes a solar panel, a first battery configured to be charged with electric power generated by the solar panel, a converter configured to convert electric power stored in the first battery and electric power generated by the solar panel, a second battery configured to be charged with the electric power converted by the converter, and processing circuitry. The converter includes a capacitor configured to reduce a potential difference between the second battery and the converter using a stored charge. The processing circuitry is configured to charge the capacitor by supplying electric power generated by the solar panel and electric power stored in the first battery to the capacitor, and start charging the second battery after charging the capacitor until an amount of charge of the capacitor is greater than or equal to a first prescribed value.

Other features and aspects will be apparent from the following detailed description, the drawings, and the claims.

### BRIEF DESCRIPTION OF THE DRAWINGS

FIG. 1 is a schematic diagram of a solar charging system.

FIG. 2 is a flowchart showing a procedure of processes executed by a controller shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Schematic Configuration of Solar Charging System

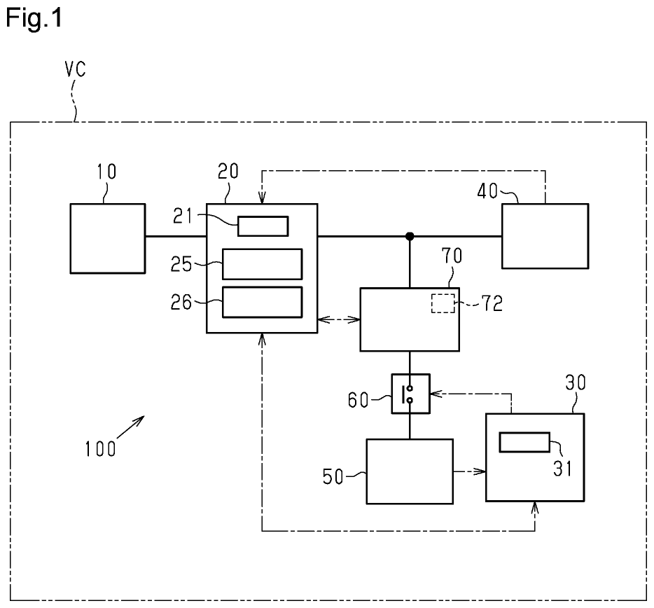

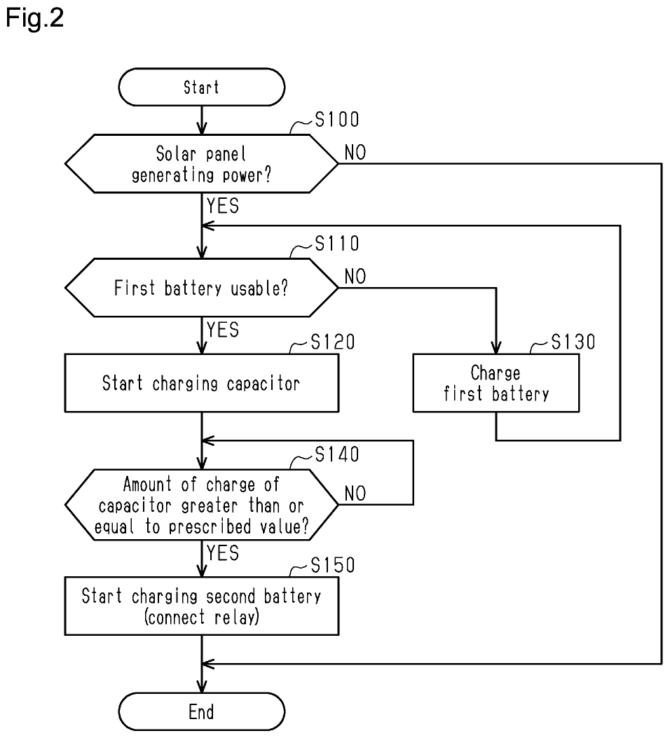

Hereinafter, an embodiment of a solar charging system will be described with reference to FIGS. 1 and 2. The solar charging system of the present embodiment is mounted on a vehicle.

As shown in FIG. 1, the solar charging system 100 includes a solar panel 10, a control unit 20, a battery monitoring unit 30, a first battery 40, a second battery 50, a relay 60, and a third converter 70.

The solar panel 10 is configured in a panel shape by arranging a plurality of solar cells that generate power by irradiation with sunlight. The solar panel 10 is installed on, for example, a roof of the vehicle VC.

The control unit 20 includes a controller 21, a first converter 25, and a second converter 26.

The controller 21 includes a CPU and a storage device. The CPU of the controller 21 executes various types of control such as power generation control of the solar panel 10, charge control of the first battery 40, and charge control of the second battery 50 by executing programs stored in the storage device of the controller 21. The first converter 25 is a DC-DC converter that converts electric power generated by the solar panel 10. The second converter 26 is a DC-DC converter that converts the electric power converted by the first converter 25 and supplies the converted electric power to the first battery 40.

The third converter 70 is a DC-DC converter that converts electric power stored in the first battery 40 and electric power generated by the solar panel 10 and supplies the converted electric power to the second battery 50. The third converter 70 has a capacitor 72 that reduces the potential difference between the second battery 50 and the third converter 70 by the stored charge.

The controller 21 controls driving of the first converter 25, the second converter 26, and the third converter 70.

The battery monitoring unit 30 includes a battery controller 31. The battery controller 31 includes a CPU and a storage device. By executing a program stored in the storage device of the battery controller 31, the CPU of the battery controller 31 monitors the state of the second battery 50 and performs opening/closing control of the relay 60 for charging the second battery 50. The battery controller 31 is connected to the controller 21 so as to be able to communicate with each other. The battery controller 31 transmits a state of the second battery 50 detected by a sensor or the like, that is, an input current, an output current, a voltage, a temperature, and the like of the second battery 50 to the controller 21. The controller 21 transmits an opening/closing instruction signal of the relay 60 to the battery controller 31.

The first battery 40 is a secondary battery that is charged with electric power generated by the solar panel 10, and is, for example, a lithium ion battery. The first battery 40 is not limited to a lithium-ion battery and may be another type of battery. The first battery 40 is an auxiliary machine battery that supplies electric power to auxiliary machines of the vehicle VC. The auxiliary machines of the vehicle VC are, for example, an electric oil pump, a navigation system, lamps, various sensors, and the like. The controller 21 acquires a state of the first battery 40 detected by a sensor or the like, that is, an input current, an output current, a voltage, a temperature, and the like of the first battery 40. The controller 21 calculates the state of charge SOC of the first battery 40 based on the acquired data. The state of charge SOC is a value obtained by dividing the current charge capacity CH of the first battery 40 by the current full charge capacity CHmax.

The second battery 50 is a secondary battery that is charged with the electric power converted by the third converter 70, that is, the electric power stored in the first battery 40 and the electric power generated by the solar panel 10. The second battery 50 is, for example, a lithium ion battery. The second battery 50 is not limited to a lithium ion battery and may be another type of battery. The second battery 50 is a driving battery that supplies electric power to a motor that drives the vehicle VC.

The relay 60 is provided in a circuit between the third converter 70 and the second battery 50. When the relay 60 is closed, electric power is transmitted and received between the third converter 70 and the second battery 50. When the relay 60 performs the opening operation, the transmission and reception of electric power between the third converter 70 and the second battery 50 are interrupted.

### Processes Executed by Controller 21

FIG. 2 shows a procedure of processing executed by the controller 21. When a request for charging the second battery 50 occurs, the controller 21 starts execution of this process. The request for charging the second battery 50 occurs, for example, when the state of charge SOC of the first battery 40 becomes greater than or equal to a prescribed threshold value. In the following description, the number of each step is represented by the letter S followed by a numeral.

When this process is started, the controller 21 determines whether or not the solar panel 10 is generating power (S100). In the S100, the controller 21 determines that the solar panel 10 is generating power when the generated power of the solar panel 10 is greater than or equal to a prescribed value WSref. The prescribed value WSref is a predetermined fit value.

In the process of S100, when it is determined that the solar panel 10 is generating power (S100: YES), the controller 21 determines whether or not the first battery 40 is usable (S110).

In the process of S110, the controller 21 acquires the current state of charge SOC of the first battery 40. When the acquired state of charge SOC is greater than or equal to the prescribed value SOCref, the controller 21 determines that the first battery 40 is usable. The prescribed value SOCref is a predetermined fit value. For example, the value of the prescribed value SOCref can be set in consideration of the electric power required for charging the capacitor 72, the power consumption of the auxiliary devices during charging of the second battery 50, and the like.

In the process of S110, when the state of charge SOC of the first battery 40 is less than the prescribed value SOCref, the controller 21 determines that the first battery 40 is not usable (S110: NO). In this case, the controller 21 charges the first battery 40 (S130). In the process of S130, the controller 21 charges the first battery 40 by supplying the electric power generated by the solar panel 10 to the first battery 40. The charging of the first battery 40 in S130 is executed until the state of charge SOC of the first battery 40 is greater than or equal to the prescribed value SOCref. When the charging of the first battery 40 is completed, the controller 21 executes the processing after S110 again.

In the process of S110, when determining that the first battery 40 is usable (S110: YES), the controller 21 starts charging the capacitor 72 (S120). In the process of S120, the controller 21 charges the capacitor 72 by supplying the electric power generated by the solar panel 10 and the electric power stored in the first battery 40 to the capacitor 72.

Next, the controller 21 determines whether the amount of charge of the capacitor 72 is greater than or equal to a prescribed value Cref (S140). The prescribed value Cref is a predetermined fit value. For example, the prescribed value Cref is an amount of charge at which the potential difference between the third converter 70 and the second battery 50 when charging of the second battery 50 is started is less than or equal to a prescribed value ΔV. The prescribed value ΔV is, for example, the maximum value of the potential difference that can suppress the inflow of the inrush current from the second battery 50 to the third converter 70.

In the process of S140, for example, the controller 21 determines that the amount of charge of the capacitor 72 exceeds the prescribed value Cref when the elapsed time from the start of charging the capacitor 72 exceeds a prescribed value. The controller 21 may determine that the amount of charge of the capacitor 72 has exceeded the prescribed value Cref when the voltage across the capacitor 72 exceeds a prescribed value. The controller 21 may determine that the amount of charge of the capacitor 72 has exceeded the prescribed value Cref when the current flowing through the capacitor 72 becomes substantially 0.

The controller 21 repeatedly executes the process of S140 until an affirmative determination is made.

In the process of S140, when determining that the amount of charge of the capacitor 72 is greater than or equal to the prescribed value Cref (S140: YES), the controller 21 starts charging the second battery 50 (S150). In the process of S150, the controller 21 outputs a signal for instructing closing of the relay 60 to the battery controller 31. Upon receiving the signal, the battery controller 31 closes the relay 60. This starts supply of electric power from the third converter 70 to the second battery 50, so that the second battery 50 starts being charged.

When the process of S150 is ended or when a negative determination is made in the process of S100, the controller 21 ends the present processing.

### Operation and Advantages of Present Embodiment

(1) In the process of S120 shown in FIG. 2, the controller 21 supplies the electric power generated by the solar panel 10 and the electric power stored in the first battery 40 to the capacitor 72. Then, after it is determined in the process of S140 that the amount of charge of the capacitor 72 is greater than or equal to the prescribed value Cref, the controller 21 starts charging the second battery 50 in the process of S150.

In this way, in the present embodiment, not only the electric power generated by the solar panel 10 but also the electric power stored in the first battery 40 is supplied to the capacitor 72. Therefore, even when the power generation amount of the solar panel 10 is unstable, the capacitor 72 of the third converter 70 can be sufficiently charged. Therefore, when charging of the second battery 50 is started, it is possible to prevent an inrush current from flowing through the third converter 70.

(2) In the process of S110 shown in FIG. 2, when it is determined that the state of charge SOC of the first battery 40 before charging of the second battery 50 is started is less than the prescribed value SOCref (S110: NO), the controller 21 executes the process of S130. In the process of S130, the controller 21 charges the first battery 40 by supplying the electric power generated by the solar panel 10 to the first battery 40. The controller 21 charges the first battery 40 until the state of charge SOC becomes greater than or equal to the prescribed value SOCref, and then performs the process of S120 to supply electric power from the first battery 40 to the capacitor 72.

In this way, when the amount of charge of the first battery 40 is small, power is supplied from the first battery 40 to the capacitor 72 after the first battery 40 is charged. Therefore, the capacitor 72 can be sufficiently charged as compared with a case where power is supplied from the first battery 40 to the capacitor 72 even though the amount of charge of the first battery 40 is small.

### Modifications

The present embodiment may be modified as follows. The present embodiment and the following modifications can be combined as long as the combined modifications remain technically consistent with each other.

If it is determined in the process of S110 shown in FIG. 2 that the first battery 40 is not usable (S110: NO), the process shown in FIG. 2 may be terminated. Also in this case, it is possible to obtain actions and effects other than the above (2).

Although the first battery 40 is an auxiliary battery that supplies electric power to an auxiliary machine of the vehicle VC, the first battery 40 may be a battery used for other purposes.

The second battery 50 is a driving battery that supplies electric power to the motor that drives the vehicle VC, the second battery 50 may be a battery used for other purposes.

Although the battery controller 31 controls the opening and closing of the relay 60, the controller 21 may directly control the opening and closing of the relay 60.

The third converter 70 may be provided in the control unit 20.

The battery controller 31 may be provided in the control unit 20.

Although the solar charging system 100 is applied to the vehicle VC, it may be applied to something other than the vehicle VC.

The controller 21 is not limited to a device that includes a CPU and a storage device and executes software processing. For example, the controller 21 may include a dedicated hardware circuit (e.g. an application specific integrated circuit: ASIC) that executes at least part of the processes executed in the above-described embodiment. That is, the controller 21 may be modified as long as it includes processing circuitry that has any one of the following configurations (a) to (c). (a) Processing circuitry including at least one processor that executes all of the above-described processes according to programs and at least one program storage device such as a ROM that stores the programs. (b) Processing circuitry including at least one processor and at least one program storage device that execute part of the above-described processes according to the programs and at least one dedicated hardware circuit that executes the remaining processes. (c) Processing circuitry including at least dedicated hardware circuit that executes all of the above-described processes. The program storage device, which is a computer-readable medium, includes any type of media that are accessible by general-purpose computers and dedicated computers.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A solar charging system, comprising:
a solar panel;
a first battery configured to be charged with electric power generated by the solar panel;
a converter configured to convert electric power stored in the first battery and electric power generated by the solar panel;
a second battery configured to be charged with the electric power converted by the converter; and
processing circuitry, wherein
the converter includes a capacitor configured to reduce a potential difference between the second battery and the converter using a stored charge, and
the processing circuitry is configured to
charge the capacitor by supplying electric power generated by the solar panel and electric power stored in the first battery to the capacitor, and
start charging the second battery after charging the capacitor until an amount of charge of the capacitor is greater than or equal to a first prescribed value.

2. The solar charging system according to claim 1, wherein the processing circuitry is configured to, when a state of charge of the first battery before starting charging the second battery is less than a second prescribed value,
charge the first battery by supplying electric power generated by the solar panel to the first battery, and
supply electric power from the first battery to the capacitor after charging the first battery until the state of charge is greater than or equal to the second prescribed value.

3. The solar charging system according to claim 1, wherein the first battery is an auxiliary battery configured to supply electric power to an auxiliary device of a vehicle.

4. The solar charging system according to claim 1, wherein the second battery is a driving battery configured to supply electric power to a motor configured to drive a vehicle.
